(19) United States
(12) Patent Application Publication
(10) Pub. No.: US 2026/0279751 A1
(43) Pub. Date: Sep. 17, 2026

(54) Systems and Methods for Purity Calculation for the Compound QC Workflow

(71) Applicant: DH Technologies Development Pte. Ltd., Singapore (SG)

(72) Inventors: Gordana IVOSEV, Etobicoke (CA); Chang LIU, Richmond HIll (CA)

(73) Assignee: DH Technologies Development Pte. Ltd., Singapore (SG)

(21) Appl. No.: 19/166,921

(22) PCT Filed: Mar. 19, 2024
(86) PCT No.: PCT/IB2024/052652

§ 371 Date: Sep. 19, 2025

Related U.S. Application Data
(60) Provisional application No. 63/491,513, filed on Mar. 21, 2023.

(51) Int. Cl. H01J 49/00; H01J 49/04

(52) U.S. Cl. CPC H01J 49/0036; H01J 49/0418

(57) ABSTRACT

A method for quantifying a purity of a target analyte in a sample includes introducing into a mass spectrometer, via a sample introduction, a plurality of sample ions generated by ionizing at least a portion of analytes in the sample; obtaining, via the mass spectrometer, a plurality of mass spectra including a sample mass spectrum associated with the sample introduction; analyzing the sample mass spectrum to identify a target signal corresponding to the target analyte; deriving, from the target signal, a target signal intensity corresponding to the target analyte; deriving, from at least a portion of the sample mass spectrum, a sample signal intensity; and quantifying the purity of the target analyte based on the target signal intensity and the sample signal intensity.

### RELATED APPLICATIONS

This application claims priority to U.S. Provisional Application No. 63/491,513 filed on Mar. 21, 2023, the contents of which are incorporated herein in their entirety.

### TECHNICAL FIELD

The present disclosure relates to methods and systems for performing mass spectrometry and more particularly to purity measurement in high throughput mass spectrometry.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

Generally, a mass spectrometer includes an ion source, an analyzer, and a detector. The ion source converts a test sample into gaseous ions, the mass analyzer separates (or mass analyzes) the gaseous ions based on their m/z ratios, and the detector detects the separated ions. One or more ion mass filters are often installed between the ion source and the analyzer to isolate the precursor ions. Further, one or more dissociation devices are often installed between mass filter and the analyzer to dissociate the isolated precursor ions for tandem mass spectrometry.

The full-scan mode of mass spectrometry (MS) of different types, such as time of flight scan mass spectrometry (TOF scan MS) or various types using quadrupoles (such as Q1 scan MS), etc., has been widely used in various applications. The full scan mode of MS greatly simplifies the MS method development, and enables not only analysis of the target species, but also identification of other ions present in the sample. The full scan mode has been utilized routinely for untargeted profiling, reaction optimization, compound QC, etc.

Since the information extraction relies on the full scan mass spectra, it would be critical to differentiate the ion signals of interest from the background ions, some of which may appear in mass spectra for multiple samples. Such differentiation is especially critical for the workflows requiring the analysis of non-targeted mass over charge (hereinafter called m/z) values. Examples of such workflows include full spectra profiling for pattern matching (e.g., in cancer diagnosis), purity assessment for the compound QC workflow, and by-product identifications for reaction optimizations.

### SUMMARY

Some embodiments relate to a method for quantifying a purity of a target analyte in a sample, the method including: introducing into a mass spectrometer, via a sample introduction, a plurality of sample ions generated by ionizing at least a portion of analytes in the sample; obtaining, via the mass spectrometer, a plurality of mass spectra including a sample mass spectrum associated with the sample introduction; analyzing the sample mass spectrum to identify a target signal corresponding to the target analyte; deriving, from the target signal, a target signal intensity corresponding to the target analyte; deriving, from at least a portion of the sample mass spectrum, a sample signal intensity; and quantifying the purity of the target analyte based on the target signal intensity and the sample signal intensity.

Some embodiments relate to a method, wherein the sample signal intensity includes a total signal intensity during a sample data acquisition period.

Some embodiments relate to a method, wherein analyzing the sample mass spectrum includes removing from the sample mass spectrum a background signal.

Some embodiments relate to a method, wherein the background signal includes a sample data acquisition period background signal associated with the sample introduction.

Some embodiments relate to a method, wherein the background signal includes a non-sample data acquisition period background signal corresponding to a non-sample mass spectrum not associated with the sample introduction.

Some embodiments relate to a method, further including direct introduction of the sample into an ionizer to generate the plurality of sample ions.

Some embodiments relate to a method, further including diluting the sample before direct introduction of the sample into the ionizer.

Some embodiments relate to a method, wherein direct introduction of the sample into the ionizer includes utilizing one or more techniques including acoustic droplet ejection (ADE), iDOT, and bio-dot.

Some embodiments relate to a method, further including introducing and ionizing the sample utilizing one or more techniques including MALDI, LDTD, LAP-MALDI, DART, DESI, acoustic mist ionization (AMI), and MALDESI.

Some embodiments relate to a method, wherein the plurality of ions include a first plurality of ions corresponding to the target analyte and a second plurality of ions corresponding to one or more non-target analytes.

Some embodiments relate to a method, wherein quantifying the purity of the target analyte includes computing a ratio of the target signal intensity and the sample signal intensity.

Some embodiments relate to a method, wherein the sample mass spectrum is obtained in a mass spectrometer scan during a sample data acquisition period.

Some embodiments relate to a method, wherein the sample mass spectrum is generated by combining a plurality of mass spectra obtained in a plurality of mass spectrometer scans during a sample data acquisition period.

Some embodiments relate to a method, wherein identifying the target signal includes identifying, in the mass spectrum, one or more isotopic signals corresponding to one or more isotopic species associated with the target analyte.

Some embodiments relate to a method, wherein quantifying the purity of the target analyte includes: determining, from the one or more isotopic signals, an isotopic intensity corresponding to the one or more isotopic species; comparing the isotopic intensity and the sample signal intensity.

Some embodiments relate to a method, wherein comparing the isotopic intensity and the sample signal intensity includes computing a ratio of the isotopic intensity and the sample signal intensity

Some embodiments relate to a method, wherein quantifying the purity of the target analyte includes: determining, from the one or more isotopic signals, a monoisotopic intensity corresponding to a monoisotopic species of the target analyte; determining, from the one or more isotopic signals, a non-monoisotopic intensity corresponding to one or more non-monoisotopic species of the target analyte; and utilizing one or more of the monoisotopic intensity and the non-monoisotopic intensity for quantifying the purity of the target analyte.

Some embodiments relate to a method, wherein: the method further includes determining a reduced sample signal intensity, wherein determining the reduced sample signal intensity includes subtracting the non-monoisotopic intensity from the sample signal intensity; and quantifying the purity of the target analyte includes computing a ratio of the monoisotopic intensity and the reduced sample signal intensity.

Some embodiments relate to a method, wherein: the method further includes determining an isotopic intensity, wherein determining the isotopic intensity includes adding the monoisotopic intensity and the non-monoisotopic intensity; and quantifying the purity of the target analyte includes computing a ratio of the isotopic intensity and the sample signal intensity.

Some embodiments relate to a method, further including identifying a composite spectrum that includes spectral interference between a non-target analyte signal and an interfered isotopic signal, wherein: the non-target analyte signal corresponds to an analyte that is included in the sample and is different from the target analyte; and the interfered isotopic signal corresponds to an interfered isotopic species associated with the target analyte.

Some embodiments relate to a method, wherein: the method further includes: estimating a contribution of the interfered isotopic species to an intensity of the composite spectrum; and utilizing the contribution of the interfered isotopic species for calculating an isotopic intensity; and quantifying the purity of the target analyte includes computing a ratio of the isotopic intensity and the sample signal intensity.

Some embodiments relate to a method, wherein the interfered isotopic species is a monoisotopic species of the target analyte.

Some embodiments relate to a method, wherein the interfered isotopic species is a non-monoisotopic species of the target analyte.

Some embodiments relate to a method, further including: determining a threshold intensity; and determining the sample signal intensity by including one or more intensities in the mass spectrum that exceed the threshold intensity.

Some embodiments relate to a method for quantifying a purity of a target analyte in a sample, the method including: ionizing one or more analytes in the sample to generate a plurality of ions, introducing the plurality of the ions into a mass spectrometer to generate a plurality of ion detection signals, utilizing a predefined criteria to identify at least one ion detection signal from among the plurality of ion detection signals, wherein the at least one identified ion detection signal includes a target ion detection signal corresponding to the target analyte, evaluating a purity of the target analyte based on an intensity of the target ion detection signal relative to an intensity associated with the at least one ion detection signal.

Some embodiments relate to a method, wherein the predefined criteria results in identification of ion detection signals required for determination of the purity of the target analyte.

Some embodiments relate to a method, wherein the predefined criteria excludes from the identification ion detection signals corresponding to a liquid carrier associated with the sample.

Some embodiments relate to a method, wherein the predefined criteria excludes from the identification ion detection signals corresponding to a vessel from which the sample was extracted.

Some embodiments relate to a system for quantifying a purity of a target analyte in a sample, the system including: a mass spectrometer configured to: receive, via a sample introduction, a plurality of sample ions generated by ionizing at least a portion of analytes in the sample; obtain a plurality of mass spectra including a sample mass spectrum associated with the sample introduction; and an analyzer module configured to: identify, in the sample mass spectrum, a target signal corresponding to the target analyte; derive, from the target signal, a target signal intensity corresponding to the target analyte; derive, from at least a portion of the sample mass spectrum, a sample signal intensity; and quantify the purity of the target analyte based on the target signal intensity and the sample signal intensity.

Some embodiments relate to a system, wherein the sample signal intensity includes a total signal intensity during a sample data acquisition period.

Some embodiments relate to a system, wherein analyzing the sample mass spectrum includes removing from the sample mass spectrum a background signal.

Some embodiments relate to a system, wherein the background signal includes a sample data acquisition period background signal associated with the sample introduction.

Some embodiments relate to a system, wherein the background signal includes a non-sample data acquisition period background signal corresponding to a non-sample mass spectrum not associated with the sample introduction.

Some embodiments relate to a system, further including a sample introducer configured for direct introduction of the sample into an ionizer to generate the plurality of sample ions.

Some embodiments relate to a system, wherein the sample introducer is further configured for diluting the sample before direct introduction of the sample into the ionizer.

Some embodiments relate to a system, wherein the sample introducer utilizes one or more techniques including acoustic droplet ejection (ADE), iDOT, and bio-dot.

Some embodiments relate to a system, further including a sample introducer configured for introducing and ionizing the sample, wherein the sample introducer utilizes one or more techniques including MALDI, LDTD, LAP-MALDI, DART, DESI, acoustic mist ionization (AMI), and MALDESI.

Some embodiments relate to a system, wherein the plurality of ions include a first plurality of ions corresponding to the target analyte and a second plurality of ions corresponding to one or more non-target analytes.

Some embodiments relate to a system, wherein quantifying the purity of the target analyte includes computing a ratio of the target signal intensity and the sample signal intensity.

Some embodiments relate to a system, wherein the sample mass spectrum is obtained in a mass spectrometer scan during a sample data acquisition period.

Some embodiments relate to a system, wherein the sample mass spectrum is generated by combining a plurality of mass spectra obtained in a plurality of mass spectrometer scans during a sample data acquisition period.

Some embodiments relate to a system, wherein identifying the target signal includes identifying, in the mass spectrum, one or more isotopic signals corresponding to one or more isotopic species associated with the target analyte.

Some embodiments relate to a system, wherein quantifying the purity of the target analyte includes: determining, from the one or more isotopic signals, an isotopic intensity corresponding to the one or more isotopic species; comparing the isotopic intensity and the sample signal intensity.

Some embodiments relate to a system, wherein comparing the isotopic intensity and the sample signal intensity includes computing a ratio of the isotopic intensity and the sample signal intensity

Some embodiments relate to a system, wherein quantifying the purity of the target analyte includes: determining, from the one or more isotopic signals, a monoisotopic intensity corresponding to a monoisotopic species of the target analyte; determining, from the one or more isotopic signals, a non-monoisotopic intensity corresponding to one or more non-monoisotopic species of the target analyte; and utilizing one or more of the monoisotopic intensity and the non-monoisotopic intensity for quantifying the purity of the target analyte.

Some embodiments relate to a system, wherein: the analyzer module is further configured to determine a reduced sample signal intensity, wherein determining the reduced sample signal intensity includes subtracting the non-monoisotopic intensity from the sample signal intensity; and quantifying the purity of the target analyte includes computing a ratio of the monoisotopic intensity and the reduced sample signal intensity.

Some embodiments relate to a system, wherein: the analyzer module is further configured to determine an isotopic intensity, wherein determining the isotopic intensity includes adding the monoisotopic intensity and the non-monoisotopic intensity; and quantifying the purity of the target analyte includes computing a ratio of the isotopic intensity and the sample signal intensity.

Some embodiments relate to a system, the analyzer module is further configured to identify a composite spectrum that includes spectral interference between a non-target analyte signal and an interfered isotopic signal, wherein: the non-target analyte signal corresponds to an analyte that is included in the sample and is different from the target analyte; and the interfered isotopic signal corresponds to an interfered isotopic species associated with the target analyte.

Some embodiments relate to a system, wherein: the analyzer module is further configured to: estimate a contribution of the interfered isotopic species to an intensity of the composite spectrum; and utilize the contribution of the interfered isotopic species for calculating an isotopic intensity; and quantifying the purity of the target analyte includes computing a ratio of the isotopic intensity and the sample signal intensity.

Some embodiments relate to a system, wherein the interfered isotopic species is a monoisotopic species of the target analyte.

Some embodiments relate to a system, wherein the interfered isotopic species is a non-monoisotopic species of the target analyte.

Some embodiments relate to a system, wherein the analyzer module is further configured to: determine a threshold intensity; and determine the sample signal intensity by including one or more intensities in the mass spectrum that exceed the threshold intensity.

Further understanding of various aspects of the embodiments may be obtained by reference to the following detailed description in conjunction with the associated drawings, which are described briefly below.

### BRIEF DESCRIPTION OF THE DRAWINGS

The drawings are not necessarily to scale or exhaustive. Instead, emphasis is generally placed upon illustrating the principles of the embodiments described herein. The accompanying drawings, which are incorporated in this specification and constitute a part of it, illustrate several embodiments consistent with the disclosure. Together with the description, the drawings serve to explain the principles of the disclosure.

In the drawings:

FIG. 1 schematically depicts a mass spectrometry system 100 according to various embodiments.

FIGS. 2A-2C show 3 views of a section of a chronogram 200 of a mass spectrum as derived by a mass spectrometer according to an embodiment.

FIGS. 3A-3C show graphs of mass spectra 310, 340, and 370, respectively corresponding to chronogram ranges 225, 215, and of chronogram 200, for the embodiments described in FIGS. 2A-2C.

FIG. 4 is an illustration of the spectra of target ions and background ions.

FIGS. 5A-5D respectively illustrate mass spectral graphs 510, 520, 530, and 540, used for sample and background ion detection according to some embodiments.

FIGS. 6 and 7 demonstrate a technique for quantifying the purity of a target analyte in a sample according to some embodiments.

FIG. 8A shows a schematic of a sample mass spectrum 800, in which the target ions correspond to multiple isotopes of the target analyte, according to some embodiments.

FIG. 8B shows a schematic of a sample mass spectrum 850, in which two non-target related spectral peaks interfere with two isotopic spectral peaks of the target ion, according to an embodiment.

FIG. 9 shows a flow chart of a method 900 for determining the purity of the target analyte according to some embodiments.

FIG. 10 schematically depicts an example of an implementation of a module 1000 according to some embodiments.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

The following detailed description refers to the accompanying drawings. The same or similar reference numbers may have been used in the drawings or in the description to refer to the same or similar parts. Also, similarly named elements may perform similar functions and may be similarly designed, unless specified otherwise. Details are set forth to provide an understanding of the exemplary embodiments. Embodiments, e.g., alternative embodiments, may be practiced without some of these details. In other instances, well known techniques, procedures, and components have not been described in detail to avoid obscuring the described embodiments.

In this disclosure, the following terms may be used with the following corresponding definitions.

A sample introduction event (SIE) corresponds to one or multiple consecutive cycles of introducing a sample into a mass spectrometry system.

A sample data acquisition period (SDAP) corresponds to a time interval during which a mass spectrometer generates spectral data for ions that are generated from at least parts of a sample introduced into the mass spectrometry system.

A non-sample period, on the other hand, corresponds to a time interval that does not fall into a SDAP and during which a mass spectrometer generates one or more mass spectra (termed non-sample mass spectra) corresponding to ions that are not generated from a sample.

A sample mass spectrum corresponds to a mass spectrum or a combination of mass spectra obtained during a SDAP and, therefore, corresponding to a sample.

A target analyte corresponds to an analyte of interest in a sample for which, for example, the purity is determined. A non-target analyte, on the other hand, corresponds to an analyte in the sample that is different from the target analyte and may, therefore, be considered as part of the impurity in the sample. A target ion corresponds to an ion generated from a target analyte and a non-target ion corresponds to an ion generated from a non-target analyte.

Typically, there may exist more than one background ion or more than one type of background ion, each having multiple isotopes. These multiple ions and isotopes may define the background m/z intensity pattern.

In some cases, such as in an Echo® MS, there may exist two types of background mass spectra corresponding to two types of background ions. These two types could cause either false positives or false negatives in the analysis results. In this disclosure these two types are called type 1 and type 2, or equivalently first type and second type, and explained below.

The first type of background mass spectrum, resulting from a first type of background ions, may be sample independent; their appearances may be constant and not dependent on the introduction of a sample into a mass spectrometer for mass analysis. This type of background ions may originate in the mobile phase (carrier solvent), ion source, or system contaminations. The first type of background mass spectrum, therefore, may appear both in the non-sample period and in the SDAP. Compared to its level in the non-sample period, the level of the first type of background ion signal during the SDAP may be the same or different; the level may be different because, during sample introduction, this type of background spectra may be enhanced (e.g. due to the pH change of the sample) or suppressed (e.g., due to the ionization suppression from the sample matrix).

The second type of background mass spectra, on the other hand, may only be present during the detection of the sample ions, that is, during the SDAP. The corresponding second type of background ions that generate the second type of background mass spectra, therefore, may appear alongside the appearance of the sample ions. In some embodiments, these background ions may be generated when the sample ions are generated but they may not originate from the analytes in the sample, but instead originate from other compounds that are present alongside the sample analytes. For example, the second type of background ions may originate in the matrix of the sample solution (e.g. sample solvent) or in the container of the sample. This type of background signal may therefore have different intensities between the non-sample period and the SDAP. Moreover, the intensity of the second type background signal may be relatively constant for the samples from the same resource/assays, but may be different from batch to batch (e.g. samples dissolved in different lots of the solvents).

Some existing methods attempt to identify and subtract background spectra from the sample spectra. These methods, however, have many shortcomings.

One possible method is to determine the mass spectra not associated with sample introduction as an estimate of the type 1 background spectra. This method, however, cannot determine the type 2 background spectra. Moreover, even in its determination of the type 1 background, it may not compensate for the potential enhancement or suppression of the type 1 background during the SDAP. Therefore, by subtracting the measured background spectra from the full spectra (i.e., spectra containing spectral mass peaks corresponding to an analyte under analysis as well as background ions, if any), the traditional methods may derive erroneous values for the sample spectra. In addition, because in some high-throughput analysis systems (e.g. Echo MS), sample signals in the time domain are close to each other, the spectra may not provide a stable period of no sample introduction for extracting the background mass spectra with this method.

Another possible method would be to measure mass spectra of a separate “blank” sample to estimate both type 1 and type 2 backgrounds. This method also suffers from several shortcomings. To begin, this method requires additional time and effort for preparing and measuring the mass spectra of the blank sample. Moreover, this method poses the challenge of creating ideal blank samples for all workflows and assays, such that the blank sample is as identical as possible to the real sample. Furthermore, this method may not compensate for the potential background scale variations among different samples, which, for example, may result from the interaction of the background ions with the sample.

Some embodiments provide methods and systems for detecting quantitative spectra of background ions or separating those spectra. Further, some embodiments utilize the detection of the background spectra for quantitative detection of compounds of interest. Some embodiments perform these operations in an unsupervised automated manner. Some embodiments also provide methods and mechanisms for measuring uncertainty in the analysis.

Some embodiments determine the scale of the background ions, therefore enabling an accurate subtraction of the background spectra from the full spectra for determining the sample spectra in an accurate manner.

Some embodiments are used to extract both type 1 and type 2 background spectra and further derive the correct scale for the background spectra to be subtracted from the sample spectra.

Some embodiments are used to determine the background ions and their intensity scales for different types of ions and in different types of MS.

In Echo® MS, in which ultrasound energy is utilized to eject a sample into an open port interface of a mass analyzer, some or all of the background ions may have the same pattern across multiple wells.

The ions of interest, on the other hand, may be different or may have different m/z intensity patterns across different SIE's. In some cases, ions of interest may appear in a subset of SIE's.

In some cases, background ion patterns may change in unknown ways across SIEs. In some cases, background ions may preserve their m/z intensity patterns such that some or all background ions have the same intensity ratios between two SIE's.

Some embodiments utilize one or more of the following steps in determining estimates of the background spectra.

Some embodiments utilize a most likely ratio (MLR) method across two sampling events.

Some embodiments may extract different features from the MLR method as estimates for existence and intensities of background ions. These estimates may not depend on the type of the background ion. Further, the extracted features may provide estimates of the spectral intensity scaling factors for each sampling event.

In some embodiments, a scaling factor for a sampling event may be a ratio of the intensity of a background spectrum for that sampling event to that intensity for a reference sampling event.

Some embodiments enable quantitative detection of background intensity and deconvolution of the detected background spectrum from the spectrum of a compound of interest. This may be done even when the peaks for the two spectra overlap completely or partially, and therefore the background contribution changes the shape or the intensity of the m/z peak of ions of interest.

Some embodiments provide a qualitative analysis of compounds of interest by subtracting scaled representative background spectra from sampling event spectra to detect ions of interest.

Some embodiments provide a quantitative analysis by determining the contribution of a background ion to a peak related to an ion of interest.

Some embodiments create an ion spectral library by subtracting the background before adding the spectrum to the spectral library.

Some embodiments incorporate the derived information about the background spectrum into the spectral library.

Some embodiments enable searching the spectrum library by using a background subtracted spectrum to achieve library matching.

Some embodiments utilize the derived sample related peaks to determine time dependent values of compound purity, degradation, fragmentation, or adduction.

Some embodiments utilize the derived data to estimate a spectral quality by, for example, comparing intensities of ions of interest against background ions or comparing spectra between two libraries to create workflows such as compound quality control (QC).

Some embodiments perform compound QC workflow, by comparing the background subtracted mass spectra against some reference spectra, or by comparing across two sets of spectra from two libraries.

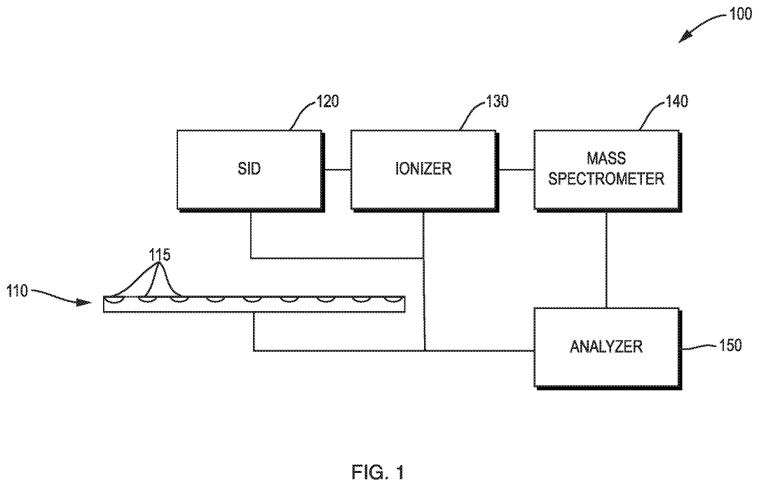

FIG. 1 schematically depicts a mass spectrometry system 100 according to various embodiments. Mass spectrometry system 100 includes a sample holder 110, a sample introducer 120, an ionizer 130, a mass spectrometer 140, and an analyzer module 150.

Sample holder 110 may be implemented as a device that includes a plurality of reservoirs 115. In some embodiments, each reservoir 115 may be a well in which one or more samples are stored. In some embodiments, each reservoir 115 stores one type of sample but different reservoirs may store different types of samples.

Sample introducer 120 may be a device that is configured to extract at least part of one or more samples from sample holder 110 (for example, from one or more of reservoirs 115) and deliver part or all of the extracted sample to ionizer 130. In some embodiments, sample introducer 120 may be an ejection system that utilizes one or more of different sources of energy for detaching samples from sample holder 110. Examples of those sources of energy include acoustic pulses, pneumatic pressure, heat, charged solvent droplet impact, laser heating, or another source of thermal energy.

Some embodiments may further include an optional sampling interface positioned between sample introducer 120 and ionizer 130. The sampling interface may, for example, receive and dilute the sample from sample introducer 120 before the sample is sent to the ionizer. In various embodiments, the sampling interface may be an Open-Port Interface (OPI) used in the Acoustic Ejection Mass Spectrometry (AEMS) technology. The OPI may, for example, receive a sample extracted from a reservoir, e.g., ejected via acoustic ejection, dilute the received sample, and transfer the sample to a downstream ionizer.

Ionizer 130 may be configured to ionize at least part of the sample that the ionizer receives, and generate a plurality of sample ions from the analytes in the received sample.

Ionizer 130 may deliver those sample ions to spectrometer 140 for data collection during a SDAP.

Mass spectrometer 140 is configured to receive the sample ions generated by ionizer 130, and detect those ions or their fragments. More specifically, mass spectrometer 140 may perform multiple mass spectral scans over the received sample ions and generate a mass spectrum for each of the scans, as further detailed below. The mass spectrum may reflect the relative number of different ions in the received sample ions. In various embodiments, a mass spectral scan may include scanning over a range of m/z values by the mass spectrometer.

In some embodiments, mass spectrometer 140 may receive sample ions from one or more samples in one or more sample introductions and, for each sample introduction, the mass spectrometer may perform one or more spectral scans. Therefore, each SDAP may on the one hand be associated with a sample and on the other hand with one or more mass spectra each obtained by a mass spectral scans performed within that SDAP, namely one or more sample mass spectra

In various embodiments mass spectrometer 140 may perform repeated mass spectral scans. Some mass spectral scans may be performed during a non-sample period and therefore provide mass spectra that do not include sample ion signals. These mass spectra, however, may include background ion signals, and in particular, background ion signals that may correspond to type one background ions, as explained above.

Some other mass spectral scans, on the other hand, may be performed during a SDAP and therefore provide mass spectra that include sample ion signals. These mass spectra may also include background ion signals corresponding to both types of background ions, as also explained above.

In various embodiments, the mass spectrometer may include various types of mass spectrometer instruments such as a quadrupole mass spectrometer, a time-of-flight (ToF) mass spectrometer, an ion trap mass spectrometer, a triple quadrupole mass spectrometer, a hybrid instrument including QToF or trapping instruments, such as a linear ion trap, a 3d ion trap, an Orbitrap, an electrostatic ion trap, or a combination of these with one another, or with other types of mass spectrometers.

In some embodiments, mass spectrometer 140 may include an MS/MS mass spectrometer configured to perform MS/MS analysis of the sample ions that it receives. In such embodiments, the mass spectrometer may include a mass filter that is configured to select one or more precursor ions, and a collision cell to fragment the selected precursor ions. These fragments are then detected by an ion detector of the mass spectrometer to generate ion detection signals that may then be processed to generate a mass spectrum of the fragment ions.

Returning to system 100 of FIG. 1, analyzer module 150 may be a module configured to receive and analyze data from one or more other parts of mass spectrometry system 100. In particular, analyzer module 150 may receive one or more mass spectral data from mass spectrometer 140 and analyze those data to determine one or more characteristics of one or more of the samples. Those characteristics may include, for example, the composition and structure of one or more analytes that are present in a sample. Moreover, as further detailed below, analyzer module 150 may also derive other information that may not be directly related to a sample, such as information about background ions originating from the environment, instruments, medium, etc.

In some embodiments, analyzer module 150 may send back to spectrometer 140 data corresponding to the derived background spectra. Spectrometer 140 may utilize these background spectra in its subsequent spectral scans to, for example, exclude one or more of the background ions from the MS. An example of these embodiments is the IDA mode. As a result, even high intensity background ions may be excluded as they are not ions of interest.

The mass spectral data collected by mass spectrometer 140 may include information related to different dimensions of the measurements performed by mass spectrometer 140, such as time, intensity, and mass (or more precisely mass to charge ratio or m/z). As a result, the mass spectral data may be presented or analyzed along different dimensions.

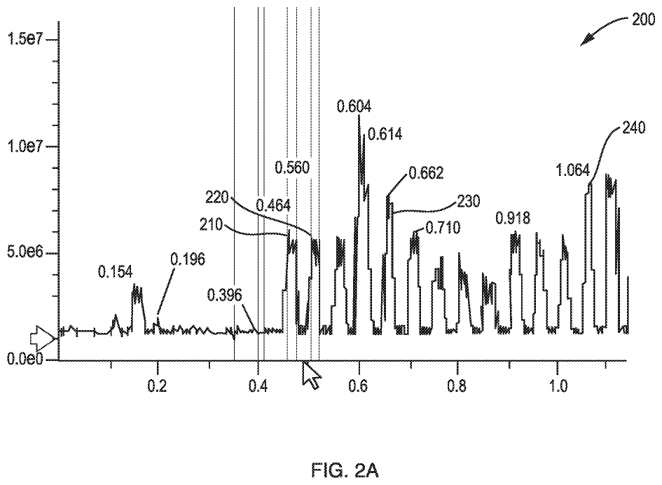

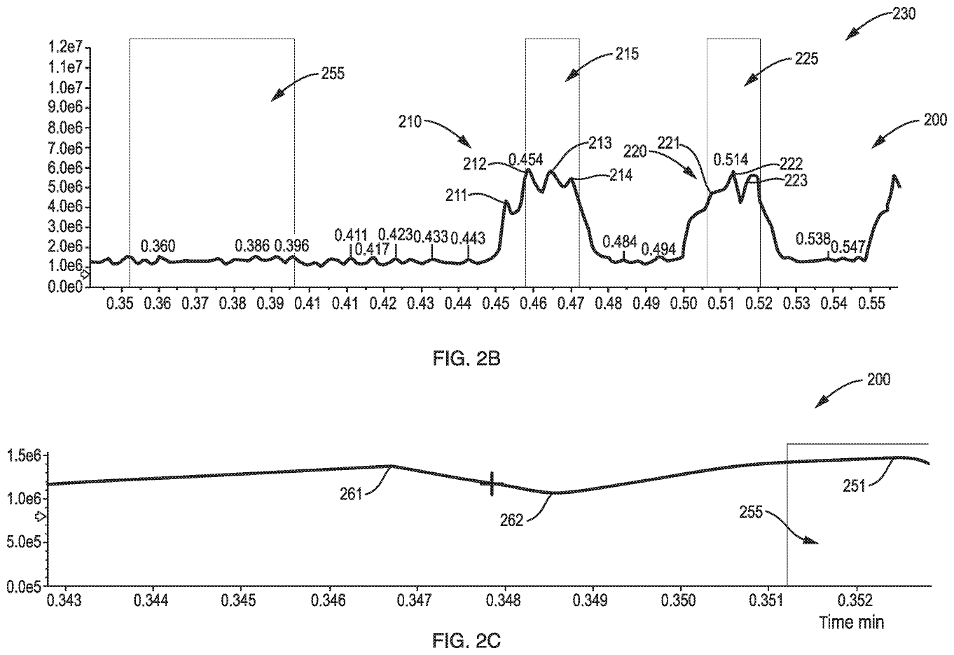

FIGS. 2A-2C show 3 views of a section of a chronogram 200 of a mass spectrum as derived by a mass spectrometer according to an embodiment. A chronogram presents the mass spectral data in the form of intensity of the detected ions as a function of time, as further detailed below.

Chronogram 200 shows a graph of the mass spectral data in the form of intensity of the detected ions as a function of time. More specifically, the Y axis depicts the intensity of the detected ions measured in counts per second (cps). The X axis, on the other hand, depicts the time of the detection of those ions measured in minutes and with respect to an arbitrary starting time, e.g., the start of one round of measurements. In some embodiments, the Y axis in the chronogram may be either the total intensity of all ions measured at a point in time (TIC), or a specific mass range (XIC). Chronogram 200, for example, corresponds to TIC.

Chronogram 200 includes multiple chronogram peaks such as chronogram peaks 210, 220, 230, and 240. Each chronogram peak may correspond to the detection of ions received by the mass spectrometer from an ionizer. Therefore, the one or more mass spectra that may be derived from each chronogram peak may correspond to one sample mass spectrum.

More specifically, Chronogram 200 includes multiple chronogram data points such as data points 211-214, 221-223, 251, 261, and 262. Each data point may correspond to a spectral scan at the corresponding time. Therefore, the chronogram may be generated by connecting the data points, and thus some data points may be recognized as those points on the chronograph at which the slope changes. While in chronogram 200 the above-listed data points have been labeled, the chronograph includes many more data points, some of which may be located between two consecutively labeled data points.

Chronogram 200 further depicts chronogram ranges 215, 225, and 255. A chronogram range may be defined by the analyzer or by a user through, for example, selecting a range of time on a graphical interface showing the chronogram. In some embodiments, after a chronogram range is defined, the analyzer averages the mass spectra that are obtained in that range and presents that average as the mass spectrum for the range. Chronogram ranges 215 and 225 respectively cover a range of time included in chronogram peaks 210 and 220, each corresponding to a SDAP. Therefore, the mass spectrum derived for each of chronogram ranges 215 and 225 corresponds to a sample mass spectrum. Chronogram range 255, on the other hand, is located outside any SDAP, that is, located in a non-sample period. Therefore, ions detected by the corresponding mass spectra may be associated with non-sample ions, for example, background ions.

Returning to the description of the above-listed data points, data points 211-214 are located inside chronogram peak 210, inside the same SDAP. Therefore, the mass spectra derived from data points 211-214 may correspond to four sample mass spectra associated with one sample to which chronogram peaks 210 corresponds. Similarly, data points 221-223 may correspond to three sample mass spectra associated with a sample to which chronogram peak 220 corresponds. In some embodiments, different chronogram peaks or different SDAPs correspond to introductions of different samples.

Data points 251, 261, and 262, on the other hand, are not associated with any SDAP. Instead, each of them is located in a non-sample period and, therefore, the mass spectrum obtained at each of these data points corresponds to a non-sample mass spectrum.

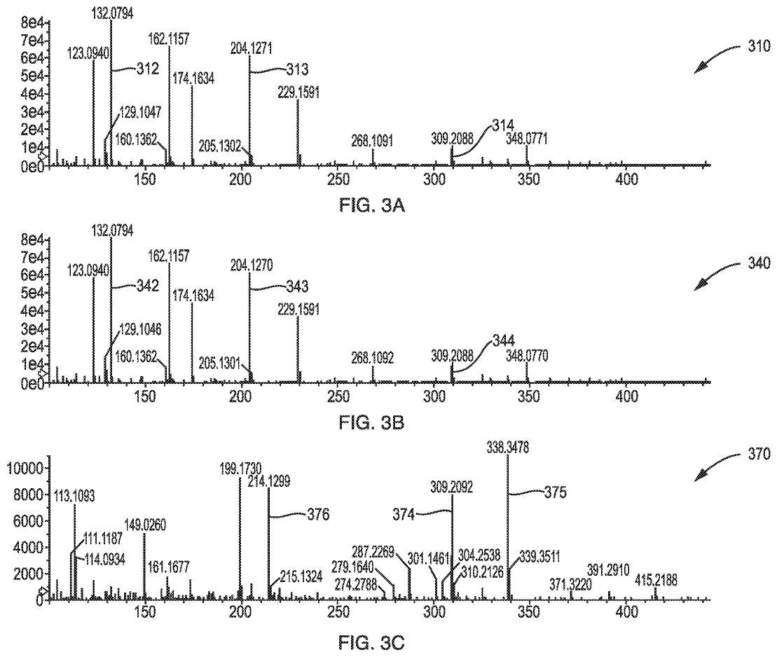

FIGS. 3A-3C show three mass spectral graphs 310, 340, and 370, respectively corresponding to chronogram ranges 225, 215, and 255 of chronogram 200 described in FIGS. 2A-2C. Therefore, as explained above, mass spectral graphs 310 and 340 correspond to two sample mass spectra (related to two consecutive SDAPs) while mass spectral graph 370 corresponds to a non-sample mass spectrum associated with a non-sample period.

Each mass spectral graph shows the mass spectral data in the form of intensity of the detected ions on the y-axis (measured in cps) as a function of m/z of the detected ions on the x-axis (measured in Daltons). More specifically, each mass spectral graph includes multiple mass spectral peaks. For example, mass spectral graph 310 includes multiple mass spectral peaks among which mass spectral peaks 312-314 are labeled; mass spectral graph 340 includes multiple mass spectral peaks among which mass spectral peaks 342-344 are labeled; and mass spectral graph 370 includes multiple mass spectral peaks among which mass spectral peaks 374-376 are labeled.

Different mass spectral graphs may include peaks at the same m/z value, which may indicate that the two mass spectra have detected the same ion. This common ion may originate from a sample analyte ion or a background ion that existed in both sets of ions detected by the two mass spectra.

In particular, most of the peaks in the two sample mass spectra 310 and 340 indicate the detection of the same analyte ions by the two mass spectra. For example, mass spectral peak 312 of mass spectrum 310 and the ion 342 of mass spectrum 340 both have an m/z value of 132.0794 Daltons. Therefore mass spectral peaks 312 and 342, both of which correspond to sample mass spectra, should indicate the detection of the same sample analyte by both mass spectra. Similarly, mass spectral peaks 313 and 343 should indicate the detection of another common sample analyte for which the detected ion has an m/z value of about 204.127 Daltons. Noteworthy is that the intensity of the common ions (indicated by the y-axis value of the corresponding peaks) is the same in the two mass spectra, that is, an intensity around 80,000 cps for the sample analyte ion detected by mass spectral peaks 312 and 342, and an intensity around 70,000 cps for the sample analyte ion detected by mass spectral peaks 313 and 343.

Comparing the two sample mass spectra 310 and 340 with the non-sample mass spectrum 370 further reveals existence of some ions in all three. Because of their existence in the non-sample mass spectrum, such ions may correspond to background ions. For example, the common m/z value of around 309.209 Daltons for mass spectral peaks 314, 344, and 374 may indicate the detection of the same background ion with that common m/z value by the three mass spectra. For this background ion, similar to the two previously discussed sample analyte ions, the intensities of the peaks in the three mass spectra around the same value of about 8000 cps (which is around one tenth of the intensities of the discussed sample analyte ions). On the other hand, some other ions in non-sample mass spectrum 370, such as 375 and 376, do not appear in the two sample mass spectra 310 and 340, indicating that they may correspond to background ions that were detected in chronogram range 255 but not in chronogram range 215 or chronogram range 225. Signal levels for these two background ions may have been suppressed in the SDAP.

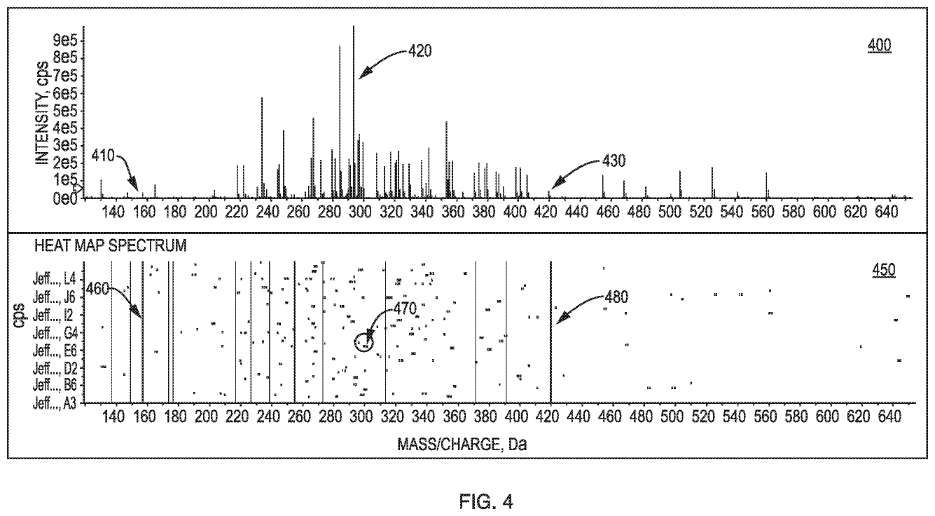

FIG. 4 is an illustration of the spectra of sample ions and background ions. As shown in the figure, there are some differences between the sample ions and the background ions. In particular, FIG. 4 shows two plots of MS data according to some embodiments. The top plot is the overlap of mass spectra from multiple samples. Similarly, the bottom plot is a heat map 450 derived from an overlap of multiple samples full scan MS data as further explained below.

The full scan MS data may include the MS data corresponding to plot 400. Spectral plot 400 illustrates intensities of mass spectra for a number of ions observed in a full scan MS run. More specifically, the X axis in this plot shows the values of m/z for ions in units of Dalton. The Y axis shows the intensity of the spectra observed for each value of m/z in units of counts per second (cps).

As seen in plot 400, the corresponding full scan MS has detected spectra for many ions in the form of many peaks of different intensities. In plot 400, three of those peaks have been labeled peaks 410, 420, and 430, for further illustration and description. These peaks indicate the existence of three ions. Peak 410 corresponds to an ion with an m/z value around 160 Daltons and an intensity less than 0.5×10⁵ cps. Similarly, peaks 420 and 430 correspond to ions with m/z values around 300 and 420 Daltons respectively, and intensities around 0.5×10⁵ and 0.5×10⁵ cps, respectively.

Heat map 450 indicates ions detected in the full scan MS data and their intensities. More specifically, the abscissa shows the m/z values for the detected ions. As may be seen from FIG. 4, the m/z values in plot 400 and heat map 450 are the same. The y coordinate of heat map 450, on the other hand, lists the plurality of full scan MS by some discrete variable, such as an identification for each scan. For each ion detected in an MS run, the heat map includes the dot at the corresponding m/z value on the X axis and the corresponding run on the Y axis. For the ions that were detected in many runs, the corresponding dots are connected to form a vertical line. Therefore, lines 460 and 480, for example, indicate that the ions corresponding to ions 410 and 430 have been detected in many MS runs. The ion corresponding to the high intensity ion 420, on the other hand, has appeared in at most a few runs such as the one circled and labeled 470.

In some embodiments, recurring appearance of an ion, such as those corresponding to peaks 410 and 430, may indicate that they may correspond to a background ion that is common among different MS runs. Ions such as the one corresponding to peak 420, on the other hand, which may appear with high intensities but not recurringly, may correspond to sample-specific ions. A sample-specific ion, may be a target ion or a sample-specific impurity.

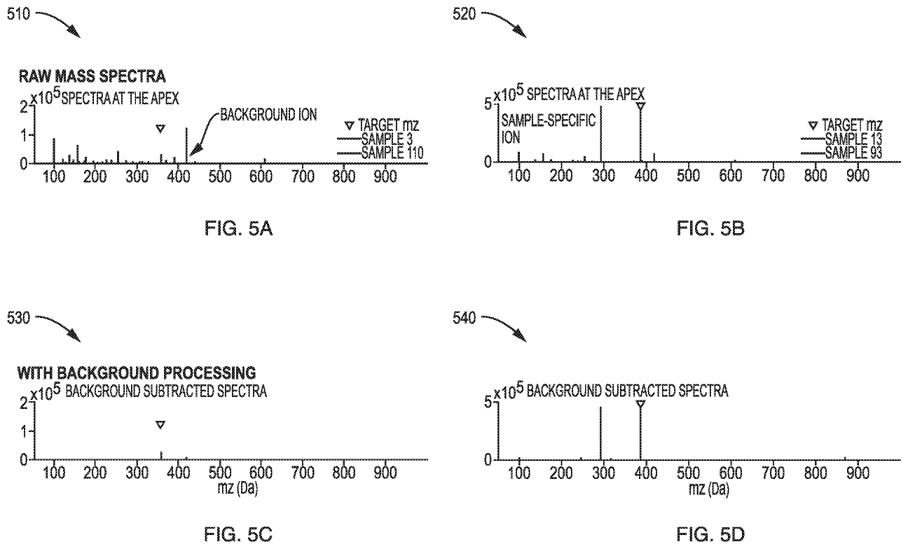

FIGS. 5A-5D respectively illustrate mass spectral graphs 510, 520, 530, and 540, used for sample and background ion detection according to some embodiments. In these graphs, on the x axis, the m/z of the ions is shown in units of Dalton. On the y axis, the count at each specific m/z value is shown in units of 105 cps.

Mass spectral graphs 510 and 520 illustrate two raw spectral data. Mass spectral graphs 530 and 540, on the other hand, illustrate the same two graphs, respectively, after subtraction of the mass spectral peaks corresponding to the background ions. The subtracted background ions may correspond to one or both types of background ions.

As illustrated in mass spectral graphs 530 and 540, a limited number of peaks may survive the background subtraction process. In mass spectral graph 530, for example, only one mass spectral peak, marked by an arrow and located at m/z around 350 Da, has survived the background identification and subtraction. This mass spectral peak may correspond to a sample ion and, more specifically, to a target ion, namely an ion of the target analyte. In mass spectral graph 540, on the other hand, two mass spectral peaks, located at m/z values around 300 Da and 400 Da, have remained after the background identification and subtraction. Of these two peaks, the second one (marked by an arrow) may correspond to a target ion, while the first one may correspond to a non-target ion, namely an ion of a non-target analyte in the sample that may be considered an impurity.

Some embodiments may utilize the mass spectral data of a sample to quantify the purity of a target analyte in the sample. In some embodiments, the purity of the target analyte may be defined as a relation between the quantity of the target analyte to the total quantity of the sample. In some embodiments, the relation may be defined as a ratio of the two quantities. Moreover, the quantity may be measured by the number of molecules, weight, volume, etc. Some embodiments utilize the mass spectral data of the sample to determine the number of the target analyte ions compared to the number of ions of all analytes in the sample.

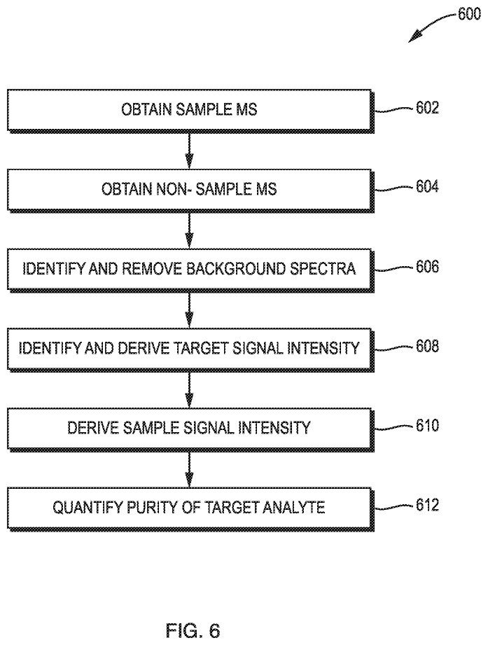

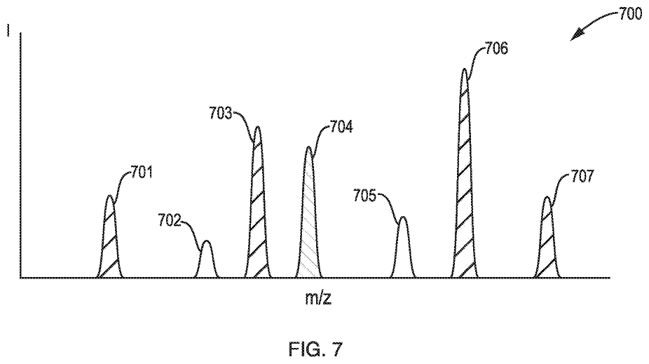

FIGS. 6 and 7 demonstrate a technique for quantifying the purity of a target analyte in a sample according to some embodiments. More specifically, FIG. 6 shows a flow chart of a method 600 for quantifying the purity of a target analyte based on a sample mass spectrum, according to some embodiments. Further, FIG. 7 shows a schematic of a sample mass spectrum 700 used for demonstrating the steps of method 600 according to some embodiments.

Method 600, as detailed below, includes 6 steps for obtaining and analyzing the sample mass spectrum. In some embodiments, method 600 may be performed by a mass spectrometry system such as mass spectrometry system 100, or by one or more parts of such a system, such as the mass spectrometer or the analyzer module, as detailed below. The schematic sample mass spectrum 700, on the other hand, includes seven mass spectral peaks 701-707, also detailed below, based on which the system may determine the purity of the target analyte in the corresponding sample.

At step 602 of method 600, the system obtains one or more sample mass spectra for the sample. As explained before, each sample mass spectrum may be obtained from one spectral scan, or averaging multiple spectral scans, each spectral scan associated with an introduction of the sample ions into the mass spectrometer. Mass spectrum 700 of FIG. 7 schematically depicts one such sample mass spectrum.

At step 604, the system further obtains one or more non-sample mass spectra corresponding to ions that are not associated with the one or more analytes in the sample. As applicable to each step of each of the disclosed methods, in some embodiments step 604 may not be performed.

At step 606, the system identifies, in the mass spectral, one or more mass spectral peaks that are associated with background ions. The system may identify one or more of the background ions as type 1 background ions (non-sample introduction background ions) or type 2 background ions (sample introduction background ions). For identifying these different types of background ion related spectral peaks, the system may analyze the one or more non-sample mass spectra or the one or more sample mass spectra in a manner described above. In particular, in some embodiments, the system may only rely on the one or more sample mass spectra. Moreover, also at step 606, the system may remove, from the one or more sample mass spectra, peaks that are associated with the background ions.

In the exemplary sample mass spectrum 700 of FIG. 7, step 606 above may be illustrated in the following manner. Of the seven spectral peaks 701-707, peaks 702 and 705 may have been identified as corresponding to background ions. More specifically, peak 702 may correspond to a sample specific background ion while peak 705 may correspond to a non-sample specific background ion. The remainder of the peaks, which are peaks 701, 703, 704, 706, and 707, may correspond to sample ions, i.e., ions generated from the analytes in the sample.

Returning to method 600 of FIG. 6, at step 608, the system may identify one or more of the spectral peaks in the mass spectrum as corresponding to the target ion. To that end, the system may use some characteristics of the target ion, for example, the mass over charge ratio (m/z) of one or more ions that may be generated by the ionizer from the target analyte. The one or more target ions may correspond to one or more isotopes of the target analyte present in the sample (as further discussed below) or one or more derivatives, such as chemical derivatives or fragments, of the target analyte.

Further, also at step 608, the system may derive a signal intensity for the target analyte. The signal intensity may be determined based on one or more characteristics of the mass spectral peaks identified as corresponding to the target analyte. Those characteristics may include, for example, the maximum intensity or the area under one or more of the identified spectral peaks.

In the exemplary mass spectrum 700, spectral peak 704 may be identified as corresponding to the target analyte because its m/z coordinate is equal to or near the m/z value of a previously known ion corresponding to the target analyte. The other sample related spectral peaks (peaks 701, 703, 706, and 707), on the other hand, may be identified as not corresponding to a known ion of the target analyte and therefore associated with the other analytes in the sample.

Further, based on the above identification of spectral peak 704, the target signal intensity may be derived as the maximum intensity of peak 704 or the total area under this peak, marked by the crossed pattern.

Returning to method 600 of FIG. 6, at step 610 the system derives an intensity for the signal corresponding to the sample mass spectrum. This sample signal intensity may, for example, correspond to the sum of the intensities of all the analytes or a subset of the analytes that are identified in the sample mass spectrum, including the target analyte.

The sample signal intensity is also illustrated in the exemplary sample mass spectrum 700. More specifically, in this example, the sample signal intensity may correspond to the sum of the intensities of some or all mass spectral peaks for the sample analytes (namely, peaks 701, 703, 704, 706, and 707). As discussed above, those intensities may be measured as the maximum intensity for each peak or the area under each peak. Therefore, for example, the sample signal intensity for spectrum 700 may be defined as the total area under the five analyte related peaks (the area that is marked by tilted line or cross patterns).

Returning to method 600 of FIG. 6, at step 612 the system quantifies the purity of the target analyte based on the target signal intensity and the sample signal intensity. In some embodiments, the analyzer module may quantify the purity of the target analyte by comparing the target signal intensity and the sample signal intensity. This comparison may indicate the purity because the target signal intensity is a function of the relative number of ions generated from the target analyte while the sample signal intensity is a function of the relative number of different sample related ions, which include ions generated from the target analyte as well as ions generated from non-target analytes. The comparison may, for example, include a determination of whether or not these two values are approximately equal in which case the purity is determined to be close to 1. The comparison may further include computing a ratio of the target signal intensity and the sample signal intensity.

In some embodiments, the analyzer may determine the purity of a target analyte based on sample mass spectra that include multiple spectral peaks corresponding to multiple isotopes of a target analyte. In some such cases, the analyzer may include those multiple peaks in determining the target signal intensity. Alternatively, the analyzer may only include the monoisotopic peak and exclude the spectral peaks that correspond to other isotopes in determining the target signal intensity and the sample signal intensity.

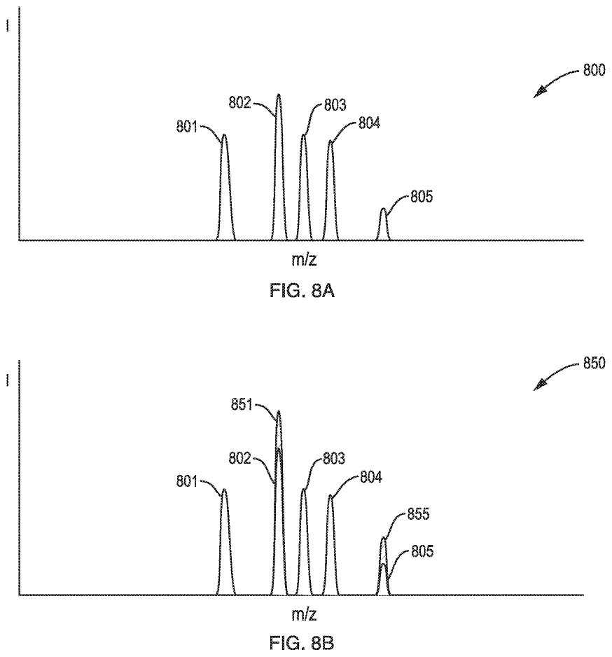

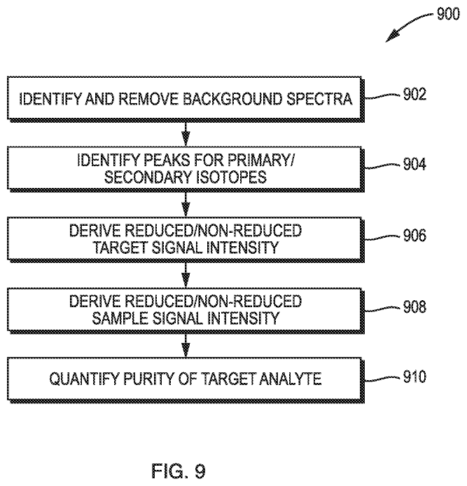

More specifically, FIG. 8A shows a schematic of a sample mass spectrum 800, in which the target ions correspond to multiple isotopes of the target analyte, according to some embodiments. Sample mass spectrum 800 includes 5 spectral peaks 801-805. Moreover, FIG. 9 shows a flow chart of a method 900 for determining the purity of the target analyte from such a mass spectrum that includes spectral peaks for multiple isotopes of the target analyte, according to some embodiments.

In method 900, at step 902, the system may obtain sample and potentially any non-sample mass spectra, accordingly identify mass spectral peaks that correspond to background ions, and remove those peaks from the sample mass spectra. The system may perform these operations in the same manner explained before.

At step 904 the system may identify multiple peaks corresponding to the target analyte. More specifically, the system may identify one or more peaks corresponding to the monoisotopic of a target analyte ion, and one or more other peaks corresponding to one or more other isotopes of the same ion. The system may identify these peaks based on their expected m/z values.

As an illustration of step 904 in sample mass spectrum 800, the analyzer may identify spectral peak 802 as corresponding to the monoisotopic ion of the target ion based on the expected m/z value for that monoisotopic ion. The analyzer may further determine the m/z value of other isotopes of the target ion and accordingly identify spectral peaks 804 and 805 as respectively corresponding to the first and second isotope of the target ion. The analyzer may further identify spectral peaks 801 and 803 as corresponding to ions generated from the non-target analytes, which would be considered impurities with respect to the target analyte.

In some embodiments, the analyzer may also predict the expected intensities of the other isotopes relative to the intensity of the monoisotopic ion based on theoretical models. Therefore, the analyzer may also verify the identification of spectral peaks 804 and 805 as corresponding to those other isotopes.

Returning to method 900 of FIG. 9, at step 906 the system may derive one or both of two types of target signal intensity. The first type of target signal intensity, called the non-reduced target signal intensity or sometimes simply target signal intensity, is determined by combining the intensities of mass spectral peaks corresponding to all isotopes of the target ion, that is, a combination of the monoisotopic ion and the other isotopes. The intensity of each spectral peak may be defined as discussed above by, for example, determining its maximum value, its area, etc. The second type of target signal intensity, which may hereinafter called the reduced target signal intensity, is determined by the intensity of the one or more spectral peaks corresponding to the monoisotopic ion of the target analyte, excluding the other isotopes.

As an illustration of step 906 in sample mass spectrum 800, the analyzer may derive the (non-reduced) target signal intensity by combining the intensities of spectral peaks 802, 804, and 805, respectively corresponding to the monoisotopic, first, and second isotopes of the target ion. On the other hand, the analyzer may derive the reduced target signal intensity by considering only spectral peak 802, which corresponds to the monoisotopic ion.

Returning to method 900 of FIG. 9, at step 908 the system may derive one or both of two types of sample signal intensity. The first type of sample signal intensity, called non-reduced sample signal intensity or simply sample signal intensity, is determined by combining the intensities of all mass spectral peaks in the mass spectrum, without excluding the mass spectral peaks of the non monoisotopic isotopes of the target ion. The second type of sample signal intensity, on the other hand, which is called reduced sample signal intensity, is determined by combining the intensities of all mass spectral peaks excluding the mass spectral peaks of non monoisotopic isotopes of the target ion.

As an illustration of step 908 in sample mass spectrum 800, the analyzer may derive the (non-reduced) sample signal intensity by combining the intensities of spectral peaks 801-805. The analyzer may, on the other hand, derive the reduced sample signal intensity by combining the intensities of spectral peaks 801-803, thus excluding the non monoisotopic peaks 804 and 805.

Returning to method 900 of FIG. 9, at step 910 the system may quantify the purity of the target analyte in one or both of two methods utilizing the above discussed intensities. In the first method, the system may compare the non-reduced target signal intensity with the non-reduced sample signal intensity. In the second method, the system may compare the reduced target signal intensity with the reduced sample signal intensity. The comparison of the intensities may include each of the methods explained before in relation to step 612 of method 600 in FIG. 6.

In some embodiments, the sample mass spectrum may include spectral interferences between a non-target related spectral peak and an isotopic spectral peak related to the target ion. The interference between two spectral peaks may occur when the m/z base of the two spectral peaks overlap either partially or in full. Such an overlap may therefore result in addition of the intensities of the two spectral peaks in the overlapped section of the m/z axis, as a result of which the intensity of one or both of those spectral peaks may not accurately reflect the intensity of the corresponding ion. In various such embodiments, the isotopic spectral peak that is affected by the interference may correspond to a monoisotopic or to another isotope of the target ion.

To illustrate such an embodiment, FIG. 8B shows a schematic of a sample mass spectrum 850, in which two non-target related spectral peaks interfere with two isotopic spectral peaks of the target ion, according to an embodiment. More specifically, sample mass spectrum 850 includes seven spectral peaks 801-805, 851, and 855. Spectral peaks 801-805 are similar to spectral peaks 801-805 of sample mass spectrum 800 in FIG. 8A, and correspond to the same isotopic spectral peaks of the target ion or spectral peaks of non-target ions. Spectral peak 851, on the other hand, corresponds to a non-target ion and interferes with monoisotopic spectral peak 802. Spectral peak 855, on the other hand, corresponds to another non-target ion and interferes with the second isotopic peak 805.

In various embodiments, the system may identify an interference and accordingly correct for its affect before determining the purity. To identify the interference, the system may, for example, compare the detected intensity of a spectral peak with an expected value for that intensity. For example, the expected value of the intensity of a spectral peak corresponding to a monoisotopic ion or a different isotope may be determined based on theoretical values for the ratio of those intensities. In some such cases, if the analyzer determines that the detected intensity for a spectral peak is different from its expected intensity, the system may determine that an interference has occurred for that spectral peak. In such a case, the analyzer may use the expected intensity of that peak in the calculations and further allocate the difference to an intensity of the interfering non-target ion signal.

In various embodiments, one or more of disclosed modules may be implemented via one or more computer programs for performing the functionality of the corresponding modules, or via computer processors executing those programs. In some embodiments, one or more of the disclosed modules may be implemented via one or more hardware units executing firmware for performing the functionality of the corresponding modules. In various embodiments, one or more of the disclosed modules may include storage media for storing data used by the module, or software or firmware programs executed by the module. In various embodiments, one or more of the disclosed modules or disclosed storage media may be internal or external to the disclosed systems. In some embodiments, one or more of the disclosed modules or storage media may be implemented via a computing “cloud”, to which the disclosed system connects via a network connection and accordingly uses the external module or storage medium. In some embodiments, the disclosed storage media for storing information may include non-transitory computer-readable media, such as a CD-ROM, a computer storage, e.g., a hard disk, or a flash memory. Further, in various embodiments, one or more of the storage media may be non-transitory computer-readable media that store data or computer programs executed by various modules, or implement various techniques or flow charts disclosed herein.

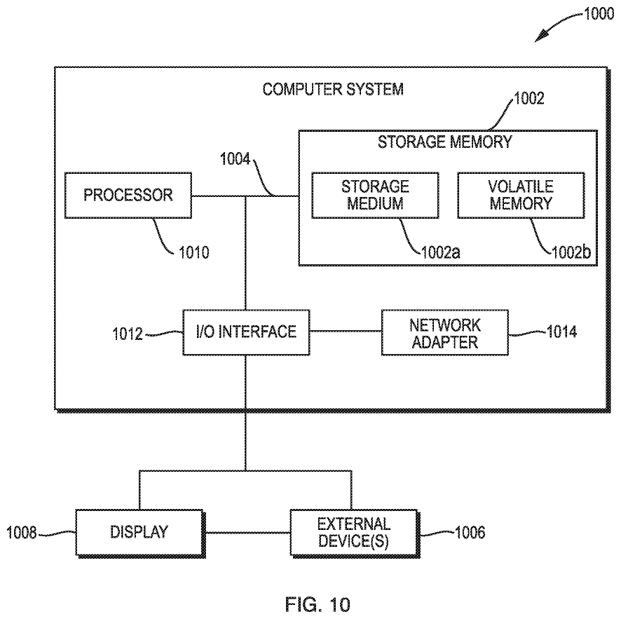

By way of example, FIG. 10 schematically depicts an example of an implementation of a module 1000 according to some embodiments. Module 1000 includes a system memory 1002 that may include a permanent memory module (e.g., ROM 1002a) and a transient memory module (e.g., RAM 1002b), an internal bus 1004, a processor 1010 (e.g., a microprocessor), an I/O interface 1012, and a communication interface 1014 (such as a network adapter). I/O interface 1012 may be in communication with one or more external input devices 1006 (such as a mouse, a keyboard, or a touch screen) or output devices 1008 (such as a display, a printer, or a speaker).

Processor 1010 and the system memory 1002 may be utilized to store and execute instructions performing the function of module 1000. Moreover, internal bus 1004 may enable communication between the processor and other parts of module 1000 such as system memory 1002, I/O interface 1012, or communication interface 1014.

Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the disclosure may be implemented in hardware and/or in software. The implementation may be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill will appreciate that various changes may be made to the above embodiments without departing from the scope of the disclosure.

Although some aspects have been described in the context of a system or an apparatus, it is clear that these aspects may also represent a description of the corresponding method, where a block or device corresponds to a method step or a feature of a method step. Analogously, aspects described in the context of a method step also represent a description of a corresponding block or item or feature of a corresponding apparatus.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or.

Moreover, if these terms are used, a set may include one or more members, and a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed compositions, systems, methods, and apparatus are not limited to any specific aspect or feature or combinations thereof, nor do the disclosed compositions, systems, methods, and apparatus require that any one or more specific advantages be present or problems be solved. Any theories of operation are to facilitate explanation, but the disclosed compositions, systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments, and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

1. A method for quantifying a purity of a target analyte in a sample, the method comprising:
introducing into a mass spectrometer, via a sample introduction, a plurality of sample ions generated by ionizing at least a portion of analytes in the sample;
obtaining, via the mass spectrometer, a plurality of mass spectra including a sample mass spectrum associated with the sample introduction;
analyzing the sample mass spectrum to identify a target signal corresponding to the target analyte;
deriving, from the target signal, a target signal intensity corresponding to the target analyte;
deriving, from at least a portion of the sample mass spectrum, a sample signal intensity; and
quantifying the purity of the target analyte based on the target signal intensity and the sample signal intensity.

2. The method of claim 1, wherein the sample signal intensity includes a total signal intensity during a sample data acquisition period.

3. The method of claim 1, wherein analyzing the sample mass spectrum includes removing from the sample mass spectrum a background signal.

4. The method of claim 3, wherein the background signal includes: a sample data acquisition period background signal associated with the sample introduction; and, optionally, a non-sample data acquisition period background signal corresponding to a non-sample mass spectrum not associated with the sample introduction.

5. (canceled)

6. The method of claim 1, further comprising directly introducing of the sample into an ionizer to generate the plurality of sample ions; and
optionally, diluting the sample before directly introducing the sample into the ionizer,
wherein, optionally, the directly introducing the sample into the ionizer comprises utilizing one or more of acoustic droplet ejection (ADE), iDOT, and bio-dot.

7. (canceled)

8. (canceled)

9. The method of claim 1, further comprising introducing and ionizing the sample utilizing one or more techniques including MALDI, LDTD, LAP-MALDI, DART, DESI, acoustic mist ionization (AMI), and MALDESI.

10. The method of claim 1, wherein the plurality of ions include a first plurality of ions corresponding to the target analyte and a second plurality of ions corresponding to one or more non-target analytes.

11. The method of claim 1, wherein the quantifying the purity of the target analyte comprises computing a ratio of the target signal intensity and the sample signal intensity.

12. The method of claim 1, wherein the sample mass spectrum is obtained in a mass spectrometer scan during a sample data acquisition period.

13. The method of claim 1, wherein the sample mass spectrum is generated by combining a plurality of mass spectra obtained in a plurality of mass spectrometer scans during a sample data acquisition period.

14. The method of claim 1, wherein identifying the target signal comprises identifying, in the mass spectrum, one or more isotopic signals corresponding to one or more isotopic species associated with the target analyte.

15. The method of claim 14, wherein quantifying the purity of the target analyte comprises:
determining, from the one or more isotopic signals, an isotopic intensity corresponding to the one or more isotopic species; and
comparing the isotopic intensity and the sample signal intensity, wherein, optionally, the comparing the isotopic intensity and the sample signal intensity comprises computing a ratio of the isotopic intensity and the sample signal intensity.

16. (canceled)

17. The method of claim 14, wherein the quantifying the purity of the target analyte comprises:
determining, from the one or more isotopic signals, a monoisotopic intensity corresponding to a monoisotopic species of the target analyte;
determining, from the one or more isotopic signals, a non-monoisotopic intensity corresponding to one or more non-monoisotopic species of the target analyte; and
utilizing one or more of the monoisotopic intensity and the non-monoisotopic intensity for quantifying the purity of the target analyte.

18. The method of claim 17, wherein:
the method further comprises determining a reduced sample signal intensity, wherein determining the reduced sample signal intensity includes subtracting the non-monoisotopic intensity from the sample signal intensity; and
quantifying the purity of the target analyte includes computing a ratio of the monoisotopic intensity and the reduced sample signal intensity.

19. The method of claim 17, wherein:
the method further comprises determining an isotopic intensity, wherein determining the isotopic intensity includes adding the monoisotopic intensity and the non-monoisotopic intensity; and
quantifying the purity of the target analyte includes computing a ratio of the isotopic intensity and the sample signal intensity.

20. The method of claim 14, further comprising identifying a composite spectrum that includes spectral interference between a non-target analyte signal and an interfered isotopic signal, wherein:
the non-target analyte signal corresponds to an analyte that is included in the sample and is different from the target analyte;
the interfered isotopic signal corresponds to an interfered isotopic species associated with the target analyte; and
optionally:
the method further comprises:
estimating a contribution of the interfered isotopic species to an intensity of the composite spectrum, and
utilizing the contribution of the interfered isotopic species for calculating an isotopic intensity; and
quantifying the purity of the target analyte includes computing a ratio of the isotopic intensity and the sample signal intensity.

21. (canceled)

22. The method of claim 20, wherein the interfered isotopic species is a monoisotopic species of the target analyte or a non-monoisotopic species of the target analyte.

23. (canceled)

24. The method of claim 1, further comprising:
determining a threshold intensity; and
determining the sample signal intensity by including one or more intensities in the mass spectrum that exceed the threshold intensity.

25. A method for quantifying a purity of a target analyte in a sample, the method comprising:
ionizing one or more analytes in the sample to generate a plurality of ions,
introducing the plurality of the ions into a mass spectrometer to generate a plurality of ion detection signals,
utilizing a predefined criteria to identify at least one ion detection signal from among the plurality of ion detection signals, wherein the at least one identified ion detection signal comprises a target ion detection signal corresponding to the target analyte, and
evaluating a purity of the target analyte based on an intensity of the target ion detection signal relative to an intensity associated with the at least one ion detection signal.

26. The method of claim 25, wherein the predefined criteria results in identification of ion detection signals required for determination of the purity of the target analyte,
wherein, optionally, the predefined criteria excludes from the identification ion detection signals corresponding to a liquid carrier associated with the sample, and
wherein, optionally, the predefined criteria excludes from the identification ion detection signals corresponding to a vessel from which the sample was extracted.

27-52. (canceled)
